(19) United States
(12) Patent Application Publication
(10) Pub. No.: US 2025/0352838 A1
(43) Pub. Date: Nov. 20, 2025

(54) CONTINUOUS FIRE PROTECTION STRIPS FOR A FIRE STOP AND FIRE STOP

(71) Applicant: Hilti Aktiengesellschaft, Schaan (LI)

(72) Inventor: Christian Förg, Buchloe (DE)

(73) Assignee: Hilti Aktiengesellschaft, Schaan (LI)

(21) Appl. No.: 18/871,538

(22) PCT Filed: May 31, 2023
(86) PCT No.: PCT/EP2023/064587

§ 371 Date: Dec. 4, 2024

(30) Foreign Application Priority Data
Jun. 14, 2022 (EP) 22178792.2

(51) Int. Cl. A62C 2/06

(52) U.S. Cl. CPC A62C 2/065

(57) ABSTRACT

A continuous fire protection strip for a fire stop has a sealing portion that has at least in part an intumescent material. The fire stop has a base strip that has at least in part a thermally insulating material and a continuous fire protecting strip. The continuous fire protection strip also has at least one first fastening portion laterally adjacent to the sealing portion. The continuous fire protection strip can be fixed to a base strip of the fire stop at least by means of the first fastening portion.

The invention relates to a continuous fire protection strip for a fire stop and a fire stop.

In the area of exterior insulation, fire stops must be used to prevent flashover from a window to the next floor. Vertical fire stops typically terminate at the rear-ventilated facade. In contrast, horizontal fire stops allow air circulation because a gap is provided between them and the facade. Particularly when rear-ventilated facades are installed, the gap required for the rear ventilation must be closed in the event of a fire so that the fire transmission is prevented for a sufficiently long time in the event of fire. For this purpose, the fire stops have a base portion having insulating material and a sealing portion having intumescent material that expands in the event of a fire and thus closes the gap.

Fire stops are generally available in a wide variety of thicknesses, depending on the distance between the facade cladding elements and the substrate. Due to the variety of the facades used and the multitude of different insulation thicknesses, manufacturers therefore have to maintain a large number of different sized fire stops, which results in high manufacturing and storage costs.

An additional complication occurs when the distance between the facade and the substrate varies a bit more. The variation of the distance results in an individual nominal thickness (with respect to the distance between the substrate and the facade) being insufficient to keep the gap small enough to comply with fire protection regulations.

The product can usually be adapted to a smaller distance. However, if the distance is greater than planned, a new product must be ordered. This slows down the timeline for this type of facade work. The problem is exacerbated in the case of architecturally appealing non-standard (slanted) facade profiles. The adjustment then results in a large amount of manual work or frequent readjustment.

The invention is therefore based on the object of providing a continuous fire protection strip and a fire stop by means of which the disadvantages of known fire stops can be eliminated or at least reduced. In particular, the respective fire protection regulations must be reliably met. In addition, it is preferable to avoid as much as possible the requirements of a large number of different production geometries and high storage costs. Furthermore, the installation effort of the fire stop for the user or installer should preferably be low.

This object is achieved by means of the subject matters of the independent claims. Advantageous embodiments are set forth in the dependent claims and the following description, each of which can represent aspects of the invention per se or in (sub) combination.

According to one aspect, a continuous fire protection strip for a fire stop is provided. The continuous fire protection strip comprises a sealing portion that has at least in part an intumescent material. The continuous fire protection strip also comprises at least one first fastening portion laterally adjacent to the sealing portion. The continuous fire protection strip can be fixed to a base strip of the fire stop at least by means of the first fastening portion.

The continuous fire protection strip configured in this way advantageously allows for a release of the sealing material (base strip of the fire stop) used to dampen the facade. In this respect, the continuous fire protection strip can be produced and used separately from the sealing material. During production, this advantageously eliminates the need for a wide variety of different production geometries that result from different applications requiring different distances between the facade cladding elements and the substrate. Advantageously, a continuous fire protection strip having uniform dimensions can be produced independently (at least independent of distance). In addition, the storage costs for the continuous fire protection strip are also reduced. Since the continuous fire protection strip is produced independently of the respective insulating material, the dimensions are reduced so that the space requirement is advantageously reduced.

For the end user or installer, independence from insulating material also has advantages. If the insulating material forms a composite with the fire protection strip, the usability of the overall unit, i.e., of the insulating material and of the fire protection strip, is prevented in the event of individual misfitting (cutting error). This results in high costs, even though the error is generally due to misfitting of the inexpensive insulation component of the overall unit and not the cost-intensive fire protection strip itself. However, because the two components are separate according to the invention, incorrect cutting results in only the more cost-effective insulating material having to be cut again. The continuous fire protection strip according to the invention can nevertheless also be used with the newly adapted component of the insulating material, at least if the error is detected before the two are undetachably coupled to one another.

In addition, there are no delays in the facade work due to incorrect cutting. Due to the separation of the continuous fire protection strip from the insulating material, misfitting does not result in the need to order a new overall unit from the manufacturer. Rather, only a new unit of the insulating material needs to be adapted, which, however, is typically always sufficiently available on site during such work. The purchase of a new fire stop (i.e., the composite of insulating material and fire protection strip), which results in a delay in the work according to known fire stops, can advantageously be avoided.

The sealing portion means the portion of the continuous fire protection strip that has the intumescent material. The intumescent material expands in the event of a fire and thus seals the gap provided for the rear ventilation. This prevents propagation of the flames between different regions in opposite directions of the gap.

In the present case, the base strip of the fire stop can means a base component comprising an insulating material that is arranged between the substrate (building part) and the facade elements. As a result, the base strip of the fire stop spans a partial distance between the substrate and the facade elements in the direction perpendicular to the respective facade element. A further partial distance is spanned by the sealing portion adjacent to the base strip of the fire stop along the direction perpendicular to the respective facade element. A residual partial distance remains along the direction perpendicular to the facade element, which corresponds to the gap provided for rear ventilation.

In the present context, “laterally adjacent to” can mean a position that extends in a direction that is oriented substantially parallel to the respective facade element in the application. This means that “laterally adjacent to” does not refer to a direction that is oriented perpendicular to the respective facade element. However, the fastening portion need not necessarily have to extend along this direction, but need only be adjacent to the sealing portion along this direction. Therefore, “laterally adjacent to” does not mean that, in the situation of use, the fastening portion cannot extend substantially along the direction perpendicular to the respective facade element.

The continuous fire protection strip preferably has a second fastening portion. The first and second fastening portions can be laterally adjacent to the sealing portion on opposite sides. In other words, the first and second fastening portions are adjacent to the sealing portion in opposite directions within a plane oriented substantially parallel to the respective facade element. The fixing with the base strip of the fire stop can be improved by the plurality of fastening portions.

Optionally, at least the first fastening portion has a first surface and a second surface opposite the first surface. At least one of the two surfaces is coated with a fastening means. The use of a fastening means allows for easy handling yet reliable fixing to the base strip of the fire stop.

The fastening means preferably comprises an adhesive.

In a particular embodiment, the sealing portion also has at least in part an elastic sealing material into which the intumescent material is embedded. For some applications, gap dimensions between the substrate and the respective facade element must be avoided. In this case, the elastic sealing material, in conjunction with the elasticity of the sealing material, ensures flexibility during installation between the substrate or the base strip of the fire stop and the facade element. In other words, the elasticity of the sealing material provides a certain clearance with respect to the distance, thus facilitating installation.

In particular, the elastic sealing material can also be compressible. As a result, the sealing portion can further facilitate installation.

The sealing material preferably has a foam. The foam can be open-pore or closed-pore. Foams are well suited to provide elasticity and compressibility.

Optionally, the sealing material is fire retardant or non-combustible. In this way, the safety with regard to the fire situation can be improved.

In a particular embodiment, outer surfaces of the sealing portion are laminated with a film at least along the longitudinal extension direction of the continuous fire protection strip. Lamination by means of the film provides strength during installation. This prevents the sealing portion or material from being damaged by activities during manufacture or installation. Furthermore, the film protects against condensation, thus providing permanent protection for the sealing material.

In the present case, “along the longitudinal extension direction” can mean an extension that comprises at least the end faces of the sealing portion along the longitudinal extension direction, both in relation to the surface opposite the respective facade element and with respect to the surface opposite the base strip of the fire stop.

Optionally, the continuous fire protection strip is also laminated with the film along its lateral extension. This means that the end faces that are oriented substantially parallel to the respective facade element in the installation situation are laminated with the film both along the longitudinal extension and along the width of the fire protection strip. Furthermore, outer surfaces of the sealing portion that are oriented substantially perpendicular to the respective facade element can also be laminated with the film.

The film preferably has a lattice structure. More preferably, the lattice structure comprises a rectangular lattice structure or a diamond lattice structure. Lattice structures have increased strength along the portions defining the lattice. Therefore, lattice structures can further improve the resistance of the film to external influences.

In one embodiment, an underside of the sealing portion has a first outer surface. An upper side opposite the underside and arranged in parallel has a second outer surface opposite the first outer surface. A height of the sealing portion (DAH) between the underside and the upper side can be between at least 4 mm and at most 50 mm, preferably between at least 15 mm and at most 30 mm, more preferably of substantially 20 mm. The underside and the upper side of the sealing portion are oriented substantially parallel to the respective facade element in the situation of use. This means that the sealing portion has a height (DAH) along the direction perpendicular to the respective facade element. The amount of intumescent material can vary depending on the height. The height can depend on the application. Thus, different gap dimensions can be closed as needed in the event of a fire based on the varying quantity of the intumescent material.

Optionally, a first width of the underside transverse to the longitudinal extension direction of the continuous fire protection strip is greater than a second width of the upper side transverse to the longitudinal extension direction of the continuous flame protection strip. This means that in this embodiment the underside and the upper side of the sealing portion have different surface dimensions per length unit. This results in a trapezoidal cross-sectional area of the sealing portion, in which the underside and the upper side are oriented parallel to one another. In contrast, the side faces connecting the underside and the upper side are beveled and are oriented so that they are not at right angles to at least one of the upper side and the underside (non-isosceles trapezoid). As a result of this geometry, the continuous fire protection strip can also be used for other applications, for example in order to line fire protection joints corresponding to wall or ceiling portions. The continuous fire protection strip can then be adapted to the respective joint geometry as required.

Transition portions that extend along the longitudinal extension direction of the continuous fire protection strip between the underside and the upper side of the sealing portion are preferably designed with bevels and/or rounded portions and/or chamfers. This avoids sharp edges between the transition portions and the underside or the upper side, thereby reducing the risk of damage.

Optionally, a first kink edge extending in the longitudinal extension direction of the continuous fire protection strip is arranged between the sealing portion and the fastening portion. The kink edge defines the boundary between the sealing portion and the fastening portion. The kink edge allows only the sealing portion to connect to the base strip of the fire stop in the situation of use along the direction perpendicular to the facade element. However, the fastening portion can be bent so that it is oriented along this direction. Ultimately, this allows the sealing portion to have a strip width that corresponds to the strip width of the base strip of the fire stop. The fastening to the base strip is then achieved by coupling, for example gluing, the fastening portion of the continuous fire protection strip to the side faces of the base strip of the fire stop (i.e., the surfaces extending along the direction perpendicular to the facade element).

The sealing portion preferably has at least one second kink edge extending in the longitudinal extension direction of the continuous fire protection strip between opposite lateral ends of the sealing portion. The second kink edge is provided for the second fastening portion and has the same function as the first kink edge.

Preferably, the sealing portion of the continuous fire protection strip can also have a carrier layer. The carrier layer can be oriented substantially parallel to an underside and an upper side of the sealing portion, the surface normals of which, in the situation of use, are oriented substantially perpendicular to the respective facade element. The intumescent material can then be arranged on both sides of the carrier layer between the carrier layer and the underside and between the carrier layer and the upper side of the sealing portion. As a result, in the event of a fire, the continuous fire protection strip expands in opposite directions starting from the carrier layer, which can be advantageous for some applications. For example, this is advantageous if the continuous fire protection strip is fixed to the base strip in such a way that the sealing portion is arranged at a distance from an end face of the base strip.

According to a further aspect, a fire stop is provided with a base strip. The base strip at least in part has a thermally insulating material. The fire stop also comprises a continuous fire protection strip as described above. The base strip has an end face, the surface normal of which is oriented substantially along the direction perpendicular to the respective facade element. The continuous fire protection strip is fixed to the base strip by means of the fastening portion in such a way that the sealing portion is arranged so as to be flush with the end face of the base strip.

In the present case, flush means that the sealing portion is arranged flush with the end face along the direction perpendicular to the respective facade element. In other words, the sealing portion of the continuous fire protection strip is arranged between the end face of the base strip and the respective facade element along the direction perpendicular to the respective facade element.

The fire stop configured in this way combines the advantages of individual insulation components and fire protection strips. The fire stop can be adapted to the respective geometry by means of the base strip as required and still reliably close the remaining gap for rear ventilation by means of the continuous fire protection strip in the event of a fire. Incorrect cutting of the base strip advantageously does not immediately render the cost-intensive fire protection component unusable.

Optionally, the sealing portion is arranged so as to be laterally spaced from and flush next to the end face of the base strip.

Alternatively, the sealing portion can also be in direct contact with the end face of the base strip. The contact can be formed in a planar manner. This means that the underside of the sealing portion can be adjacent to the end face of the base strip. A surface normal of the underside of the sealing portion is then oriented in the direction perpendicular to the respective facade element.

In addition to this, “next to” means that the distance extends substantially along the surface normal of the end face.

In a particular embodiment, the continuous fire protection strip has two fastening portions on opposite sides of the sealing strip. The first fastening portion and the second fastening portion can then be fixed on opposite sides of the base strip. The opposite sides of the base strip, to which the fastening portions are fixed, can extend substantially along the direction perpendicular to the respective facade element. This improves the fixation of the continuous fire protection strip to the base strip.

Optionally, the end face of the base strip has a width (BSB) transverse to the longitudinal extension direction of the base strip. A width of the sealing portion (DAB) transverse to the longitudinal extension direction of the continuous flame protection strip can then be equal to or less than the width (BSB) of the base strip. Preferably, the width of the sealing portion (DAB) is equal to or less than the width (BSB) of the base strip. The dimensions of the base strip and the sealing portion can thus be matched to one another.

Typically, such fire stops must be designed for the service life of the facade, i.e., at least many years. If the continuous fire protection strip is fastened to the base strip by means of an adhesive, the adhesive can lose its adhesive force over time due to the temperature fluctuations and other external influences.

Therefore, the continuous fire protection strip, and in particular the sealing portion thereof, can preferably be configured to be coupled to the base strip by means of a clamping device in such a way as to ensure that the positioning of the continuous fire protection strip relative to the base strip of the fire stop.

Alternatively, the continuous fire protection strip, and in particular the sealing portion thereof, can also be coupled to the respective facade element by means of a spring device in such a way as to ensure that the positioning of the continuous fire protection strip relative to the base strip of the fire stop.

All of the features explained with respect to the various aspects can be combined individually or in (sub-) combination with other aspects.

The invention and further advantageous embodiments and developments thereof are described and explained in more detail below with reference to the examples shown in the drawing. The features found in the description and the drawing can be applied individually or together in any combination according to the invention. In the drawings:

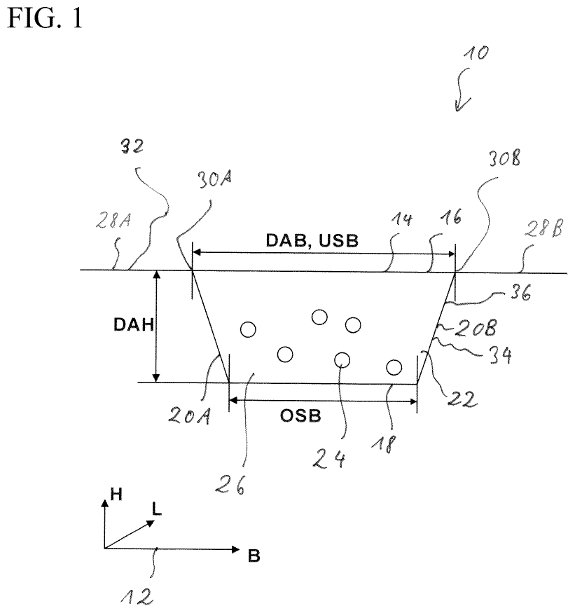

FIG. 1 shows a simplified schematic representation of a continuous fire protection strip according to an embodiment,

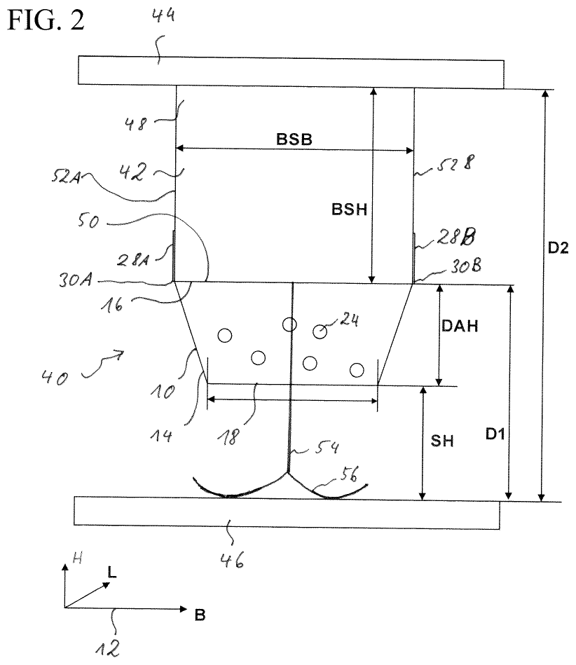

FIG. 2 shows a simplified schematic representation of a fire stop having a continuous fire protection strip according to one embodiment,

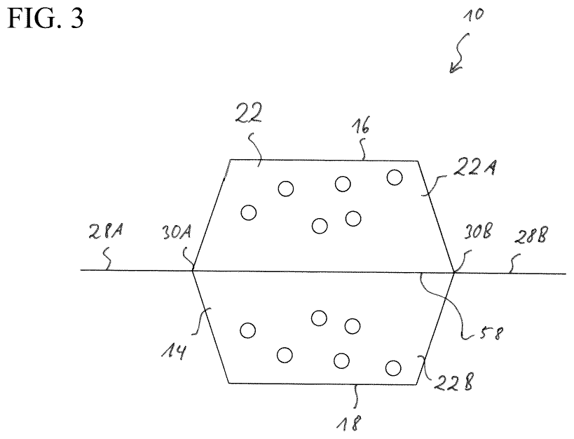

FIG. 3 shows a simplified schematic representation of a continuous fire protection strip according to a further embodiment,

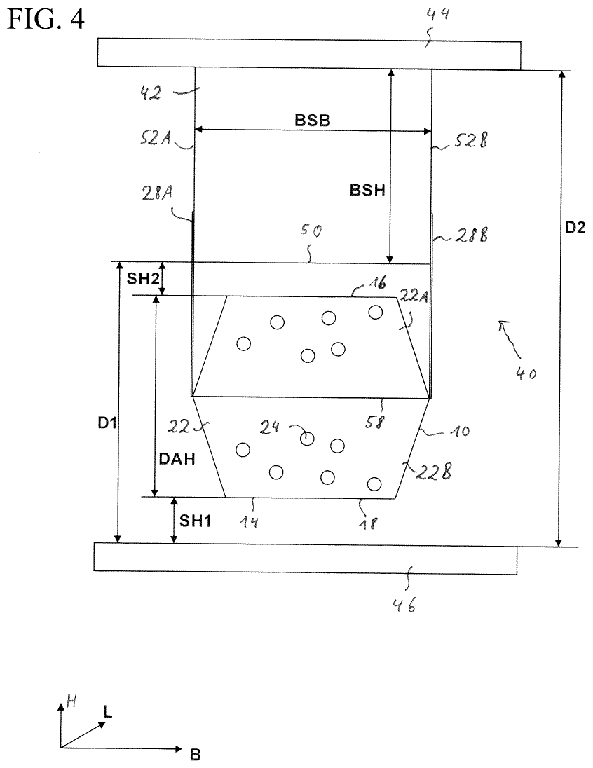

FIG. 4 shows a simplified schematic representation of a fire stop having a continuous fire protection strip according to a further embodiment,

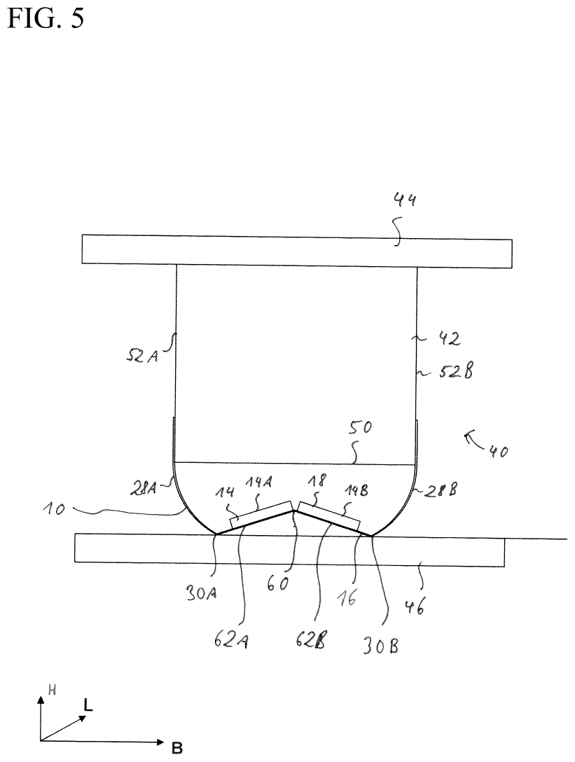

FIG. 5 shows a simplified schematic representation of a fire stop having a continuous fire protection strip according to a further embodiment, and

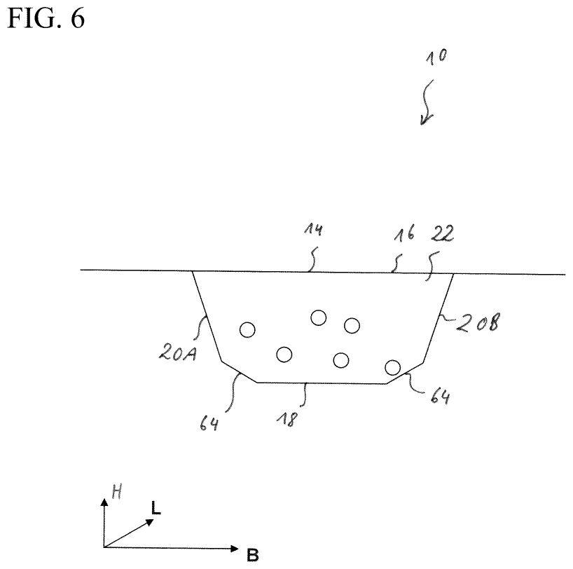

FIG. 6 shows a simplified schematic representation of a continuous fire protection strip according to a further embodiment.

All features disclosed below with respect to the exemplary embodiments and/or accompanying figures can be combined, alone or in any sub-combination, with features of the aspects of the present disclosure, including features of preferred embodiments, provided that the resulting feature combination is useful to a person skilled in the art in the field of technology.

FIG. 1 shows a simplified schematic representation of a continuous fire protection strip 10 according to one embodiment.

The coordinate system 12 illustrates the usual orientations of the continuous fire protection strip 10 in the situation of use with respect to the length L, which in the present case lies in the drawing plane, the width B and the height H. The coordinate system 12 is typically to be related to the facade element arranged opposite the continuous fire protection strip 10 in the situation of use because a constant gap dimension is generally to be realized between the continuous fire protection strip 10 and the facade element. This means that the height H is oriented substantially along the surface normal with respect to the facade element.

The continuous fire protection strip 10 comprises a sealing portion 14. The sealing portion 14 comprises an underside 16 that extends along the width and the length. In the present case, the width of the sealing portion 14 is denoted by DAB. The sealing portion 14 also comprises an upper side 18 that is oriented parallel to the underside 16 and is arranged at a distance from the latter. Due to the distance between the underside 16 and the upper side 18, the sealing portion 14 has a sealing portion height DH.

The underside 16 and the upper side 18 are connected to one another by transition portions 20A, 20B. In the situation of use, the transition portions 20A, 20B extend along the longitudinal extension direction of the continuous fire protection strip 10.

Because of the underside 16, the upper side 18 and the transition portions 20A, 20B, the sealing portion 14 has an inner volume 22 per unit length. An intumescent material 24 is arranged at least in part in the inner volume 22. Furthermore, an at least in part elastic sealing material 26 can be arranged in the inner volume 22. The sealing material 26 can also be compressible. In the present case, the sealing material 26 is also non-combustible. Alternatively, the sealing material can also be conditionally combustible. The sealing material 26 is generally selected based on the legal requirements with regard to its combustibility.

In the present case, the upper side 18 has a shorter upper side width OSB along the width compared to the underside 16 and the corresponding underside width USB. This results in a trapezoidal cross-sectional area of the inner volume 22.

In the present case, the transition portions 20A, 20B have the same inclination relative to the underside 16. In other words, the angle enclosed by the underside 16 is the same for both transition portions 20A, 20B so that, according to this embodiment, a cross-sectional area of the inner volume 22 corresponding to an isosceles trapezoid is present. Optionally, however, the angles can also be different, resulting in a cross-sectional area corresponding to a non-isosceles trapezoid.

In the present case, the continuous fire protection strip 10 is shown according to its manufacturing configuration. The fastening portions are laterally adjacent to the sealing portion 14. In the present case, they also extend along the width B. In the present case, the fastening portions 28A, 28B adjoin the underside 16 of the sealing portion 14. Along the longitudinal extension direction of the continuous fire protection strip 10, and therefore in the drawing plane in the present case, the continuous fire protection strip 10 has a first kink edge 30A and a second kink edge 30B. The respective fastening portions 28A, 28B are pivotable about the first and second kink edges 30A, 30B so that said fastening portions then no longer need to extend along the width B. In the situation of use, the fastening portions 28A, 28B can therefore be oriented at least in part along the height H.

Furthermore, the fastening portions 28A, 28B have a fastening means 32, in this case an adhesive, at least on one surface.

Optionally, the underside 16 and/or the upper side 18 and/or the transition portions 20A, 20B and/or the fastening portions 28A, 28B can be laminated with a film 34 at least on their outer surfaces. The film 34 can have a lattice structure 36. This improves the strength and resistance of the portions extending along the longitudinal extension direction of the continuous fire protection strip 10, so that the risk of damage during manufacture or installation is reduced.

FIG. 2 shows a simplified schematic illustration of a fire stop 40 having a continuous fire protection strip 10 according to one embodiment.

The fire stop 40 comprises a base strip 42 that extends from a base 44 of the respective building along the height H in the direction of the opposite facade element 46. The base strip 42 has a width BSB and a height BSH.

The height distance D2 between the substrate 44 and the facade element 46 is thereby at least in part bridged by the base strip 42 and its height BSH, so that a residual height distance D1 is obtained.

The base strip 42 generally comprises an insulating material 48 provided for thermal building insulation.

Optionally, the insulating material 48 can be fire retardant or non-combustible.

An end face 50 of the base strip 42 of the fire stop 40 is arranged opposite the respective facade element 46. In the present case, the end face 50 is oriented parallel to the facade element 46.

The continuous fire protection strip 10 is generally arranged between the base strip 42 of the fire stop 40 and the respective facade element 46. In particular, the continuous fire protection strip 10 is arranged with respect to its sealing portion 14 so as to be flush with the end face 50 along the height direction H with respect to the opposite facade element 46.

Due to the height DAH of the sealing portion 14 of the continuous fire protection strip 10, the residual height distance D1 between the base strip 42 and the respective facade element 46 is in part spanned by the sealing portion 14. This results in a gap height SH along the height direction between the sealing portion 14 and the facade element 46. The gap height SH is used for rear ventilation of the facade.

In particular applications, provision can also be made for no gap to be present for rear ventilation.

According to this embodiment, the underside 16 of the sealing portion 14 is directly adjacent to the end face 50 of the base strip 42. The underside 16 is therefore in direct contact with the end face 50. The fastening portions 28A, 28B are pivoted about the respective kink edges 30A, 30B so that they extend along the height direction H and are coupled to side faces 52A, 52B of the base strip 42. The fastening means 32, in the present case the adhesive, are used for the coupling.

In the event of a fire, the intumescent material 24 expands so that the sealing portion 14 expands in the direction of the facade element 46. Finally, the gap height SH can thus be closed by the expanding intumescent material 24. Thus, the fire can be prevented from propagating from a room side of the base strip 42 to the opposite room side of the base strip 42.

Due to the fact that the continuous fire protection strip 10 is generally separate from the base strip 42 of the fire stop 40, in the case of complex facade geometries, the base strip 42 can first be adapted to the facade geometry and the continuous fire protection strip 10 can subsequently be arranged thereon. If the base strip 42 is misfit, the separation of the continuous fire protection strip 10 from the base strip 42 ensures that only the relatively cost-effective base strip 42 needs to be replaced or adapted. This prevents the cost-intensive component of the continuous fire protection strip 10 from becoming unusable due to a defective height dimension BSH of the base strip 42.

According to this embodiment, the fire stop 40 further has a spring device 54, which is used to ensure the positioning of the continuous fire protection strip 10 relative to the base strip 42. The spring device 54 extends at least in part through the sealing portion 14 of the continuous fire protection strip 10 and has two spring arms 56 that support the spring device 54 on the opposite facade element 46. As a result, the positioning of the continuous fire protection strip 10 relative to the base strip 42 is ensured even in the event that the adhesive, which according to this embodiment, is used for fastening the fastening portions 28A, 28B to the side surfaces 52A, 52B of the base strip 42, loses its adhesive strength over time.

FIG. 3 shows a simplified schematic representation of a continuous fire protection strip 10 according to a further embodiment. In the present case, only the differences from the preceding embodiment are discussed.

According to this embodiment, the sealing portion 14 of the continuous fire protection strip 10 now has two partial volumes 22A, 22B of the inner volume 22. The inner volume 22 is interrupted by a carrier layer 58. Starting from the carrier layer 58, the partial volumes 22A, 22B extend in the direction of the underside 16 and the upper side 18.

Optionally, the carrier layer 58 can also be laminated with a film 34. This ensures sufficient mechanical stability of the carrier layer 58.

The height DH of the sealing portion 14 then extends over the carrier layer 58.

FIG. 4 shows a simplified schematic illustration of a fire stop 40 having a continuous fire protection strip 10 according to a further embodiment. In the present case, only the differences from the preceding embodiment are discussed.

The continuous fire protection strip 10 now has a sealing portion 14 having two partial volumes 22A, 22B of the inner volume 22. The inner volume 22 is interrupted by the carrier layer 58 with respect to the partial volumes 22A, 22B.

According to this embodiment, the fastening portions 28A, 28B have larger expansions. The continuous fire protection strip 10 is coupled to the side faces 52A, 52B of the base strip 42 by means of the fastening portions 28A, 28B. In the present case, the fastening portions 28A, 28B are designed in particular such that the continuous fire protection strip 10 is arranged so as to be flush with the end face 50 along the height direction H with respect to the end face 50 of the base strip 42, but is spaced apart therefrom. In other words, there is a first gap height SH1 between the facade element 46 and the upper side 18 of the sealing portion 14 along the height direction H, and a second gap height SH2 between the underside 16 of the sealing portion 14 and the end face 50 of the base strip 42. The first gap height SH1 and the second gap height SH2 result in the total gap dimension that is not spanned by the continuous fire protection strip 10 with respect to the residual height distance D1 between the base strip 42 and the facade element 46.

For some applications, the rear ventilation provided along the height direction H on both sides of the continuous fire protection strip 10 can be advantageous.

FIG. 5 shows a simplified schematic illustration of a fire stop 40 having a continuous fire protection strip 10 according to a further embodiment. In the present case, only the differences from the preceding embodiments are discussed.

For certain applications, it can be desirable for the continuous fire protection strip 10 to lie at least in part against the opposing facade element 46.

In the present case, the continuous fire protection strip 10 is supported on the facade element 46 in the region of the kink edges 30A, 30B. The underside 16 of the sealing portion 14 extends between the kink edges 30A, 30B, which underside, in contrast to the preceding exemplary embodiments, is arranged opposite the facade element 46 and thus not opposite the end face 50 of the base strip 42. In contrast to the preceding embodiments, the end face 50 of the base strip 42 is opposite the upper side of the sealing portion 14.

In addition, the underside 16 has a kink point 60 about which a first subsection 62A of the underside 16 is pivoted relative to a second subsection 62B of the underside 16.

Furthermore, in the present case, the sealing portion 14 is subdivided into two partial regions 14A, 14B. In each case, a partial region 14A, 14B is assigned to a subsection 62A, 62B of the underside 16 of the sealing portion 14. The subsections 14A, 14B are spaced apart from one another by the kink point 60.

Alternatively, the sealing portion 14 can also extend beyond the kink point 60.

The kink point 60 prevents the sealing portion 24 from being in direct surface contact with the facade element 46, which could result in a delay in the expansion of the intumescent material 24 in the event of a fire.

In the present embodiment, an additional spring device 54 is not required. Rather, the spring action can be provided by the fastening portions 28A, 28B, which can be optionally reinforced for this purpose. In order to counteract aging of the fastening means 32, the fastening portions 28A, 28B can optionally be additionally secured in the region of the side faces 52A, 52B of the base strip 42 by suitable devices, for example clamping devices.

FIG. 6 shows a simplified schematic representation of a continuous fire protection strip according to a further embodiment. In the present case, only the differences from the preceding embodiments are discussed.

The sealing portion 14 in turn has an inner volume 22 that is defined by the underside 16, the upper side 18 and the transition portions 20A, 20B. In contrast to the previous embodiments, chamfers 64 are arranged between the upper side 18 and the transition portions 20A, 20B in order to avoid sharp-edged profiles of the contour of the sealing portion 14. This can reduce the risk of damage to the sealing portion 14 during manufacture or installation.

As an alternative to the chamfers 64, corresponding rounded portions can also be provided.

Furthermore, the chamfers 64 or rounded portions can also be provided in other regions, for example in the transitions between the transition portions 20A, 20B and the underside 16 of the sealing portion 14.

The present disclosure may refer to amounts and numbers. Unless expressly stated, such amounts and numbers are not to be considered as limiting, but as examples of the possible amounts or numbers in connection with the present disclosure. In this context, the term “plurality” may also be used in the present disclosure to refer to an amount or number. In this context, the term “plurality” refers to any number that is greater than one, for example, two, three, four, five, etc. The terms “about,” “approximately,” “close to” etc. mean plus or minus 5% of the given value.

1. A continuous fire protection strip for a fire stop, having a sealing portion that has at least in part an intumescent material and at least one first fastening portion laterally adjacent to the sealing portion, wherein the continuous fire protection strip is configured to be fixed to a base strip of the fire stop at least by the at least one first fastening portion.

2. The continuous fire protection strip according to claim 1, wherein the continuous fire protection strip has a second fastening portion and that the at least one first fastening portion and the second fastening portion are adjacent to the sealing portion on opposite sides thereof.

3. The continuous fire protection strip according to claim 1, wherein at least the at least one first fastening portion has a first surface and a second surface opposite the first surface, and in that at least one of the two surfaces is coated with a fastening.

4. The continuous fire protection strip according to claim 1, wherein the sealing portion further has at least in part an elastic sealing material into which the intumescent material is embedded.

5. The continuous fire protection strip according to claim 4, wherein the sealing material is fire retardant or non-combustible.

6. The continuous fire protection strip according to claim 1, wherein outer surfaces of the sealing portion are laminated with a film at least along a longitudinal extension direction of the continuous fire protection strip.

7. The continuous fire protection strip according to claim 6, wherein the film has a lattice structure.

8. The continuous fire protection strip according to claim 1, wherein an underside of the sealing portion has a first outer face, in that an upper side opposite the underside and arranged in parallel has a second outer face opposite the first outer face, and in that a height, DAH, of the sealing portion between the underside and the upper side is between at least 4 mm and at most 50 mm.

9. The continuous fire protection strip according to claim 8, wherein a first width, USB, of the underside transverse to the longitudinal extension direction of the continuous fire protection strip is greater than a second width, OSB, of the upper side transverse to the longitudinal extension direction of the continuous fire protection strip.

10. The continuous fire protection strip according to claim 8, wherein transition portions that extend along the longitudinal extension direction of the continuous fire protection strip between the underside and the upper side of the sealing portion are designed with bevels and/or rounded portions and/or chamfers.

11. The continuous fire protection strip according to claim 1, wherein a first kink edge extending in the longitudinal extension direction of the continuous fire protection strip is arranged between the sealing portion and the at least one first fastening portion.

12. The continuous fire protection strip according to claim 1, wherein the sealing portion has at least one second kink edge extending in the longitudinal extension direction of the continuous fire protection strip between opposite lateral ends of the sealing portion.

13. The fire stop having a base strip, having at least in part a thermally insulating material and a continuous fire protection strip according to claim 1, wherein the base strip has an end face, wherein the continuous fire protection strip is fixed to the base strip by the at least one first fastening portion such that the sealing portion is arranged flush relative to the end face of the base strip.

14. The fire stop according to claim 13, wherein the sealing portion is arranged to be laterally spaced from and flush next to with the end face of the base strip.

15. The fire stop according to claim 13, wherein the at least one first fastening portion and the second fastening portion are fixed on opposite side surfaces of the base strip.

16. The continuous fire protection strip according to claim 7, wherein the film has a rectangular lattice structure or a diamond lattice structure.

17. The continuous fire protection strip according to claim 8, wherein an underside of the sealing portion has a first outer face, in that an upper side opposite the underside and arranged in parallel has a second outer face opposite the first outer face, and in that a height, DAH, of the sealing portion between the underside and the upper side is of substantially 20 mm.
